(19) United States
(12) Patent Application Publication
(10) Pub. No.: US 2024/0167411 A1
(43) Pub. Date: May 23, 2024

(54) ELECTRICALLY HEATING CATALYTIC CONVERTER

(71) Applicants: NGK INSULATORS, LTD., Nagoya-Shi (JP); TOYOTA JIDOSHA KABUSHIKI KAISHA, Toyota-Shi (JP)

(72) Inventors: Takashi TAKADA, Nagoya-Shi (JP); Hitomi FURUKAWA, Otsu-Shi (JP); Takahiro SADAMITSU, Miyoshi-Shi (JP); Toshinori OKI, Toyota-Shi (JP); Shingo KORENAGA, Nagoya-Shi (JP); Yoshio YAMASHITA, Susono-Shi (JP)

(73) Assignees: NGK INSULATORS, LTD., Nagoya-Shi (JP); TOYOTA JIDOSHA KABUSHIKI KAISHA, Toyota-Shi (JP)

(21) Appl. No.: 18/502,132

(22) Filed: Nov. 6, 2023

(30) Foreign Application Priority Data
Nov. 22, 2022 (JP) 2022-186750

(51) Int. Cl. F01N 3/28; F01N 3/20

(52) U.S. Cl. CPC F01N 3/28; F01N 3/20

(57) ABSTRACT

An electrically heating catalytic converter according to the present invention includes: a honeycomb structure 1 having an outer peripheral wall and partition walls defining a plurality of cells; a pair of metal electrodes 2 connected to the honeycomb structure 1; and a housing 3 provided with an inlet 30 and an outlet 31, the housing 3 storing the honeycomb structure 1 therein, wherein the honeycomb structure 1 has a plurality of regions comprising a central region including an axial center of the honeycomb structure and an outer peripheral region adjacent to the outer peripheral wall, wherein the opening percentage of the central region is less than or equal to 0.9 times that of the outer peripheral region, and wherein a diameter of the central region is more than or equal to 65% and less than or equal to 135% of that of the inlet of the housing.

### FIELD OF THE INVENTION

The present invention relates to an electrically heating catalytic converter.

### BACKGROUND OF THE INVENTION

In general, electrically heating catalytic (EHC) converters are known. The electrically heating catalytic converters are for purifying an exhaust gas emitted when an engine (internal combustion engine) is in a cold state immediately after the engine is started, by arranging electrodes on a honeycomb structure made of conductive ceramics, and heating the honeycomb structure itself by electric conduction to increase a temperature of a catalyst supported on the honeycomb structure to an activation temperature before starting the engine.

The electrically heating catalysts are required to withstand thermal shock from exhaust gases from engines. Patent Literature 1 described below proposes to provide an opening percentage distribution in a radial direction of a honeycomb structure, thereby adjusting the flow of the exhaust gas, and suppress a difference in thermal expansion within the honeycomb structure to alleviate the thermal shock due to the exhaust gas.

### CITATION LIST

### Patent Literature

[Patent Literature 1] WO 2015/151823 A1

### SUMMARY OF THE INVENTION

As a result of intensive studies for electrically heating catalytic converters using the conventional honeycomb structure as described above, the present inventors have found that there is a need for an improved response to thermal shock when an engine load increases.

The present invention has been made to solve the above problems. An object of the present invention is to provide an electrically heating catalytic converter that can improve a response to thermal shock when an engine load increases.

### Aspect 1.

In an embodiment, the present invention relates to an electrically heating catalytic converter, comprising: a honeycomb structure having an outer peripheral wall and partition walls disposed on an inner side of the outer peripheral wall, the partition walls defining a plurality of cells each extending from one end face to other end face to form a flow path; a pair of metal electrodes connected to the honeycomb structure to apply voltage to the honeycomb structure; and a housing provided with an inlet and an outlet for allowing an exhaust gas from an engine to flow therethrough, the housing storing the honeycomb structure therein between the inlet and the outlet, wherein the honeycomb structure has a plurality of regions disposed coaxially with each other in a cross section orthogonal to an extending direction of the cells, the plurality of regions having different opening percentages from each other, wherein the plurality of regions comprise a central region including an axial center of the honeycomb structure and an outer peripheral region adjacent to the outer peripheral wall, wherein the opening percentage of the central region is less than or equal to 0.9 times that of the outer peripheral region, and wherein a diameter of the central region is more than or equal to 65% and less than or equal to 135% of that of the inlet of the housing.

### Aspect 2.

The present invention may relate to the electrically heating catalytic converter according to Aspect 1, wherein the plurality of regions further comprise an intermediate region disposed between the central region and the outer peripheral region, and wherein the opening percentage of the intermediate region is larger than the opening percentage of the central region and less than the opening percentage of the outer peripheral region.

### Aspect 3.

The present invention may relate to the electrically heating catalytic converter according to Aspect 1 or 2, wherein the thickness of the partition walls in the central region is more than or equal to 1.3 times and less than or equal to 2.3 times that of the partition walls in the outer peripheral region.

### Aspect 4.

The present invention relates to the electrically heating catalytic converter according to any one of Aspects 1 to 3, wherein the opening percentage of the central region is more than or equal to 0.65 times and less than or equal to 0.8 times that of the outer peripheral region.

### Aspect 5.

The present invention may relate to the electrically heating catalytic converter according to any one of Aspects 4 to 4, wherein the honeycomb structure further comprises a pair of electrode layers provided on the outer surface of the outer peripheral wall so as to extend in a band shape in the extending direction of the cells across an axial center of the honeycomb structure.

According to an embodiment of electrically heating catalytic converter of the present invention, it is possible to improve a response to thermal shock when an engine load increases.

### BRIEF DESCRIPTION OF THE DRAWINGS

FIG. 1 is an explanatory view showing an electrically heating catalytic converter according to an embodiment of the present invention;

FIG. 2 is a perspective view showing the honeycomb structure in FIG. 1;

FIG. 3 is an enlarged front view of one cell and a part of surrounding cells in FIG. 2;

FIG. 4 is an explanatory view showing a first form of the honeycomb structure shown in FIG. 2; and

FIG. 5 is an explanatory view showing a second form of the honeycomb structure in FIG. 2.

### DETAILED DESCRIPTION OF THE INVENTION

Hereinafter, embodiments for carrying out the present invention will be described with reference to the drawings. The present invention is not limited to each embodiment, and components can be modified and embodied without departing from the spirit of the present invention. Further, various inventions can be formed by appropriately combining a plurality of components disclosed in each embodiment. For example, some components may be removed from all of the components shown in the embodiments. Furthermore, the components of different embodiments may be optionally combined.

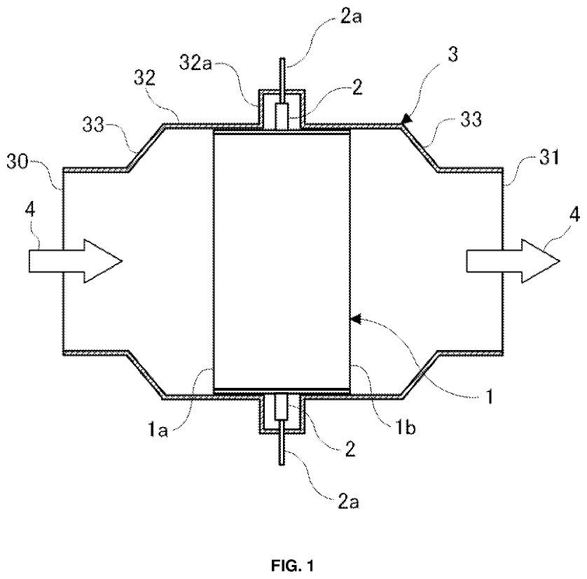

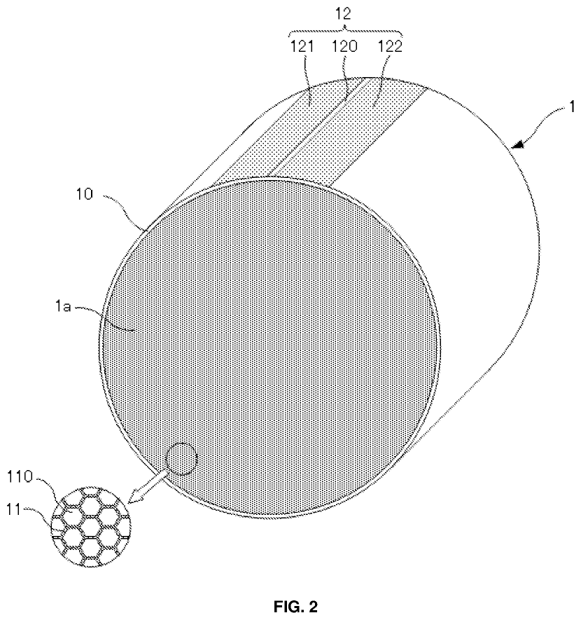

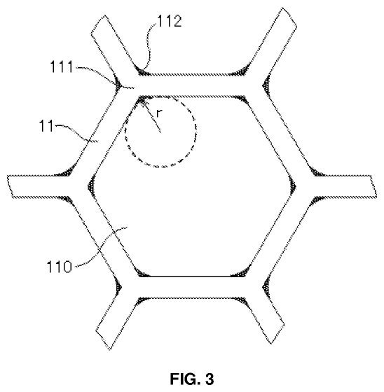

FIG. 1 is an explanatory view showing an electrically heating catalytic converter according to an embodiment of the present invention, FIG. 2 is a perspective view showing a honeycomb structure 1 in FIG. 1, and FIG. 3 is an enlarged front view of one cell 110 and a part of surrounding cells 110 in FIG. 2. The electrically heating catalytic converter shown in FIG. 1 is installed, for example, on an exhaust path of a vehicle or the like equipped with an engine, and is used to purify an exhaust gas 4 discharged from the engine.

As shown in FIG. 1, the electrically heating catalytic converter according to this embodiment includes a honeycomb structure 1, a pair of metal electrodes 2, and a housing 3.

### <Regarding Honeycomb Structure>

The honeycomb structure 1 is a pillar shaped member made of ceramics. As shown in FIG. 2, the honeycomb structure 1 includes: an outer peripheral wall 10; and partition walls 11 which are disposed on an inner side of the outer peripheral wall 10 and define a plurality of cells 110 each extending from one end face 1a to other end face 1b (see FIG. 1) to form a flow path. It is understood that the pillar shape is a three-dimensional shape having a thickness in an extending direction of the cells 110 (an axial direction of the honeycomb structure 1). A ratio of a length of the honeycomb structure 1 in the axial length to a diameter of the end face 1a, 1b of the honeycomb structure 1 (aspect ratio) is arbitrary. The pillar shape may also include a shape in which the length of the honeycomb structure 1 in the axial direction is shorter than the diameter of the end face 1a, 1b (flat shape).

An outer shape of the honeycomb structure 1 is not particularly limited as long as it has a pillar shape. For example, it can be a pillar shape having circular end faces 1a, 1b (cylindrical shape), a pillar shape having oval end faces 1a, 1b, and other shapes such as a pillar shape having polygonal (rectangular, pentagonal, hexagonal, heptagonal, octagonal, etc.) end faces 1a, 1b. Also, as for the size of the honeycomb structure 1, an area of the end faces 1a, 1b is preferably from 2,000 to 20,000 mm², and even more preferably from 5,000 to 15,000 mm², in order to increase heat resistance (to suppress cracks generated in the circumferential direction of the outer peripheral wall 10).

The axial length of the honeycomb structure 1 is preferably 40 to 200 mm, and more preferably 60 to 150 mm.

A shape of each cell 110 in the cross section orthogonal to the extending direction of the cells 110 may preferably be a quadrangle, hexagon, octagon, or a combination thereof, although not limited thereto. Among these, the quadrangle and the hexagon are preferred. Such a cell shape can lead to a decreased pressure loss when the exhaust gas 4 flows through the honeycomb structure 1, which can provide improved purification performance.

The partition walls 11 that define the cells 110 preferably have a thickness of from 0.08 to 0.3 mm, and more preferably from 0.1 to 0.2 mm. The thickness of 0.08 mm or more of the partition walls 11 can suppress a decrease in the strength of the honeycomb structure 1. The thickness of the partition walls 11 of 0.3 mm or less can suppress a larger pressure loss when the exhaust gas 4 flows through the honeycomb structure 1 if the honeycomb structure 1 is used as a catalyst support to support a catalyst. In the present invention, the thickness of the partition walls 11 is defined as a length of a portion passing through the partition wall 11, among line segments connecting the centers of gravity of adjacent cells 110, in the cross section orthogonal to the extending direction of the cells 110.

As shown in FIG. 3, R portions 112 may be formed at an intersection portion 111 of each of the partition walls 11. The R portions 112 are portions formed so as to be thicker at the intersection portion 111 such that each surface is formed into an “inwardly recessed circular arc shape”. The R portions 112 result in the surfaces of the partition walls 11 that are smoothly connected in a circular arc shape at the intersection portion 111. That is, the corners of the cell 110 in the cross-sectional shape are arcuate. A radius r of the circular arc of each R portion 112 is preferably 0.05 to 0.6 mm.

The honeycomb structure 1 preferably has a cell density of from 40 to 150 cells/cm², and more preferably from 70 to 100 cells/cm², in the cross section orthogonal to the extending direction of the cells 110. The cell density in such a range can allow the purification performance of the catalyst to be increased while reducing the pressure loss when the exhaust gas flows. The cell density of 40 cells/cm² or more can allow a catalyst supported area to be sufficiently ensured. The cell density of 150 cells/cm² or less can prevent the pressure loss when the exhaust gas 4 flows through the honeycomb structure 1 from being increased if the honeycomb structure 1 is used as a catalyst support to support the catalyst. The cell density is a value obtained by dividing the number of cells by the area of one end face portion of the honeycomb structure 1 excluding the outer peripheral wall 10 portion.

The provision of the outer peripheral wall 10 of the honeycomb structure 1 is useful from the viewpoints of ensuring the structural strength of the honeycomb structure 1 and suppressing the leakage of a fluid flowing through the cells 110 from the outer peripheral wall 10. Specifically, the thickness of the outer peripheral wall 10 is preferably 0.05 mm or more, and more preferably 0.10 mm or more, and even more preferably 0.15 mm or more. However, if the outer peripheral wall 10 is too thick, the strength will be too high, and a strength balance between the outer peripheral wall 10 and the partition wall 11 will be lost, resulting in a decrease in thermal shock resistance. Therefore, the thickness of the outer peripheral wall 10 is preferably 1.0 mm or less, and more preferably 0.7 mm or less, and even more preferably 0.5 mm or less. The thickness of the outer peripheral wall 10 is defined as a thickness of the outer peripheral wall in the normal line direction relative to the tangent line at a measured point when the point of the outer peripheral wall 10 where the thickness is to be measured is observed in the cross section orthogonal to the extending direction of the cells 110.

The honeycomb structure 1 is made of ceramics and is preferably electrically conductive. Volume resistivity is not particularly limited as long as the honeycomb structure 1 is capable of heat generation by Joule heat when a current is applied. Preferably, the volume resistivity is from 0.1 to 200 Ωcm, and more preferably from 1 to 200 Ωcm. As used herein, the volume resistivity of the honeycomb structure 1 refers to a value measured at 25° C. by the four-terminal method.

The honeycomb structure 1 can be made of a material selected from the group comprising oxide ceramics such as alumina, mullite, zirconia and cordierite, and non-oxide ceramics such as silicon carbide, silicon nitride and aluminum nitride, although not limited thereto. Further, silicon carbide-metal silicon composite materials and silicon carbide/graphite composite materials can also be used. Among these, it is preferable that the material of the honeycomb structure 1 contains ceramics mainly based on a silicon-silicon carbide composite material or silicon carbide, in terms of balancing heat resistance and electrical conductivity. The phrase “the material of the honeycomb structure 1 is mainly based on silicon-silicon carbide composite material” means that the honeycomb structure 1 contains 70% by mass of more of silicon-silicon carbide composite material (total mass) based on the total material. Here, the silicon-silicon carbide composite material contains silicon carbide particles as an aggregate and silicon as a binding material to bind the silicon carbide particles, preferably in which a plurality of silicon carbide particles are bound by silicon such that pores are formed between the silicon carbide particles. The phrase “the material of the honeycomb structure 1 is mainly based on silicon carbide” means that the honeycomb structure 1 contains 70% or more of silicon carbide (total mass) based on the total material.

When the honeycomb structure 1 contains the silicon-silicon carbide composite material, a ratio of the “mass of silicon as a binding material” contained in the honeycomb structure 1 to the total of the “mass of silicon carbide particles as an aggregate” contained in the honeycomb structure 1 and the “mass of silicon as a binding material” contained in the honeycomb structure 1 is preferably from 10 to 40% by mass, and more preferably from 15 to 35% by mass.

The partition walls 11 may be porous. When the partition walls 11 are porous, the porosity of the partition walls 11 is preferably from 35 to 60%, and even more preferably from 35 to 45%. The porosity is a value measured by a mercury porosimeter. Further, the partition walls 11 may be dense, and when they are dense, the partition walls 11 may have a porosity of 10% or less, or 5% or less.

The partition walls 11 of the honeycomb structure 1 preferably have an average pore diameter of from 2 to 15 μm, and even more preferably from 4 to 8 μm. The average pore diameter is a value measured by a mercury porosimeter.

The honeycomb structure 1 may further include a pair of electrode layers 12. The pair of electrode layers 12 according to the present embodiment are provided on the outer surface of the outer peripheral wall 10 so as to extend in a band shape in the extending direction of the cells 110 across the central axis of the honeycomb structure 1. In FIG. 2, only one of the pair of electrode layers 12 is shown. It should be noted that, in relation to the electrode layer 12, the outer peripheral wall 10 and the partition walls 11 may be collectively referred to as a honeycomb structure portion. That is, it may be understood that the honeycomb structure 1 includes the honeycomb structure portion having the outer peripheral wall 10 and the partition walls 11, and the pair of electrode layers 12.

The pair of electrode layers 12 may each has a separation zone 120 and first and second partial electrode layers 121, 122 separated by the separation zone 120. The separation zone 120 may be a slit provided between the first and second partial electrode layers 121, 122. The slit may be filled with a material having a higher volume resistivity than that of the electrode layer 12. The separation zone 120 and the first and second partial electrode layers 121, 122 may extend from one end to the other end of the honeycomb structure 1 in the extending direction of the cells 110. The first and second partial electrode layers 121, 122 are strip-shaped with a predetermined width in the circumferential direction of the honeycomb structure 1, and the separation zone 120 is linear and has a narrower width than the first and second partial electrode layers 121, 122. However, the method of arranging the separation zone 120 and the first and second partial electrode layers 121, 122 is not limited to this embodiment as long as they can be connected to a pair of metal electrodes 2 as described below.

The volume resistivity of the electrode layers 12 is preferably 1/200 or more and 1/10 or less of the electric resistivity of the honeycomb structure 1, in terms of facilitating the flow of electricity to the electrode layers 12.

Each electrode layer 12 may be made of conductive ceramics, a metal, or a composite material (cermet) of a metal and a conductive ceramic. Examples of the metal include a single metal of Cr, Fe, Co, Ni, Si or Ti, or an alloy containing at least one metal selected from the group consisting of those metals. Non-limiting examples of the conductive ceramics include silicon carbide (SiC), and metal compounds such as metal silicides such as tantalum silicide (TaSi₂) and chromium silicide (CrSi₂).

As a method for producing the honeycomb structure 1 having the electrode layers 12, first, an electrode layer forming raw material containing ceramic raw materials is applied onto a side surface of a honeycomb dried body and dried to form a pair of unfired electrode layers on the outer surface of the outer peripheral wall so as to extend in the form of band in the extending direction of the cells 110, across the central axis of the honeycomb dried body, thereby providing a honeycomb dried body with unfired electrode layers. Then, the honeycomb dried body with unfired electrode layers is fired to produce a honeycomb fired body having a pair of electrode layers. The honeycomb structure 1 having the electrode layers 12 is thus obtained.

By supporting a catalyst on the honeycomb structure 1 (honeycomb structure portion), the electrically heating support can be used as a catalyst body. Examples of the catalyst include noble metal-based catalysts and catalysts other than those. Illustrative examples of the noble metal catalysts include three-way catalysts and oxidation catalysts having a noble metal such as platinum (Pt), palladium (Pd), and rhodium (Rh) supported on surfaces of alumina pores, and containing a co-catalyst such as ceria and zirconia; or lean NOx trap catalysts (LNT catalysts) containing an alkaline earth metal and platinum as storage components for nitrogen oxides (NOx). Examples of catalysts that do not use noble metals include NOx catalytic reduction catalysts (SCR catalysts) containing copper-substituted or iron-substituted zeolites, and the like. Further, two or more types of catalysts selected from those catalysts may be used. A method of supporting the catalyst is also not particularly limited, and it can be carried out according to the conventional method of supporting the catalyst on the honeycomb structure 1.

### <Regarding Metal Electrodes>

A pair of metal electrodes 2 are connected to the honeycomb structure 1 and are used to apply voltage to the honeycomb structure 1. As shown in FIG. 1, cables 2a are connected to the pair of metal electrodes 2. An external power source such as a battery (not shown) is connected to the cables 2a. By applying a voltage to the honeycomb structure 1 through the metal electrodes 2, the honeycomb structure 1 can be made to generate heat. One of the pair of metal electrodes 2 is understandable as a positive electrode, and the other is understandable as a negative electrode.

The pair of metal electrodes 2 may be spaced apart from each other in the circumferential direction of the honeycomb structure 1. The pair of metal electrodes 2 may be disposed across the central axis of the honeycomb structure 1. The metal electrodes 2 may be connected to the outer peripheral surface of the honeycomb structure 1. When the honeycomb structure 1 has the electrode layers 12, the metal electrodes 2 may be connected to the outer surfaces of the electrode layers 12 (first and second partial electrode layers 121, 122). When the honeycomb structure 1 does not have the electrode layers 12, the metal electrodes 2 may be connected to the outer surface of the outer peripheral wall 10. The metal electrodes 2 can be fixed to the outer peripheral surface of the honeycomb structure 1 by any method such as welding or thermal spraying.

### <Regarding Housing>

As shown in FIG. 1, the housing 3 is provided with an inlet 30 and an outlet 31 for allowing an exhaust gas 4 from an engine to flow therethrough. The inlet 30 is provided at one end of the housing 3, through which the exhaust gas 4 can flow into the housing 3. The outlet 31 is provided at the other end of the housing 3, through which the exhaust gas 4 can flow out of the housing 3. The housing 3 stores the honeycomb structure 1 therein between the inlet 30 and the outlet 31. The exhaust gas 4 flowing in from the inlet 30 passes through the cells 110 of the honeycomb structure 1 toward the outlet 31. The honeycomb structure 1 may be arranged coaxially with the inlet 30 and the outlet 31.

Each of the inlet 30 and outlet 31 may have a diameter (inner diameter) of 30 to 100 mm. The shape of each of the inlet 30 and the outlet 31 is typically circular as viewed along the flow direction of the exhaust gas 4. However, the shapes of the inlet 30 and the outlet 31 are not limited thereto, and they may be other shapes such as an oval shape or a polygonal (quadrangular, pentagonal, hexagonal, heptagonal, octagonal, etc.) shape. When the inlet 30 and the outlet 31 has shapes other than the circular shape, the diameter of each of the inlet 30 and the outlet 31 is understandable to be a diameter of the largest inscribed circle of each of the inlet 30 and the outlet 31.

The housing 3 may include a housing portion 32 and a pair of increased diameter portions 33.

The housing portion 32 is a portion which has a larger diameter (inner diameter) than the inlet 30 and the outlet 31, and which accommodates and holds the honeycomb structure 1. The housing portion 32 may be arranged between the inlet 30 and the outlet 31, more specifically in the center of the housing 3 in the flow direction of the exhaust gas 4. The outer diameter of the honeycomb structure 1 may be approximately the same as the diameter of the housing portion 32. That is, the outer diameter of the honeycomb structure 1 may be larger than the diameter of each of the inlet 30 and the outlet 31. A sheet-like mat may be interposed between the outer surface of the honeycomb structure 1 and the housing portion 32.

The housing portion 32 may be provided with electrode chambers 32a for storing the metal electrodes 2. Each electrode chamber 32a may be provided with an opening for pulling out the cable 2a to the outside. Although each metal electrode 2 is shown as having a pillar shape in FIG. 1, each electrode chamber 32a may be omitted depending on the shape of the metal electrode 2.

The increased diameter portions 33 are portions which are provided between the inlet 30 and the housing portion 32 and between the outlet 31 and the housing portion 32, and which have diameters gradually increasing from the inlet 30 or the outlet 31 to the housing portion 32. The increased diameter portions 33 may be omitted and the inlet 30 and/or the outlet 31 and the housing portion 32 may be arranged adjacent to each other.

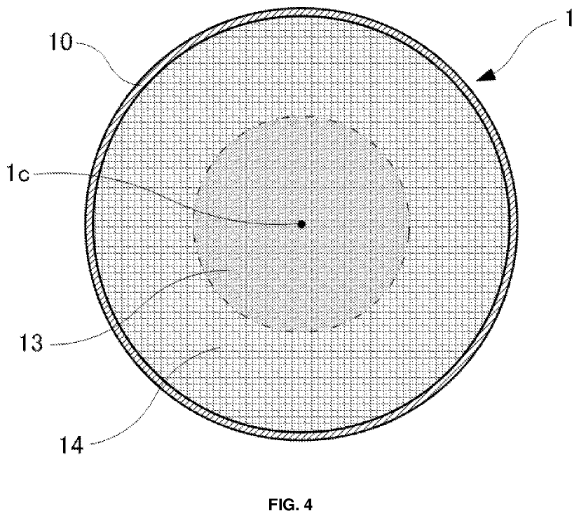

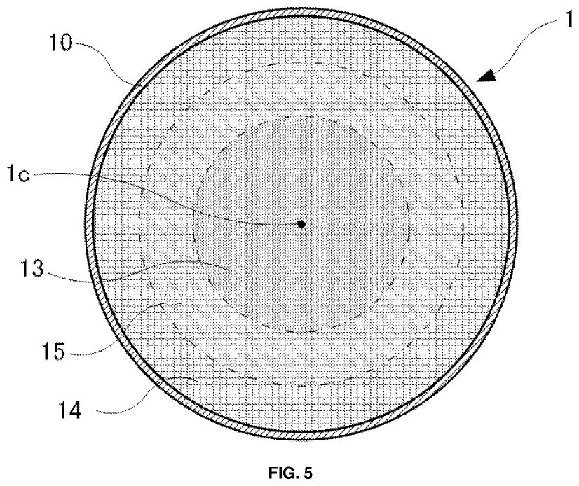

Next, FIG. 4 is an explanatory view showing a first form of the honeycomb structure 1 in FIG. 2, and FIG. 5 is an explanatory view showing a second form of the honeycomb structure 1 in FIG. 2. Each of FIGS. 4 and 5 shows a cross section of the honeycomb structure 1 orthogonal to the extending direction of the cells 110.

The honeycomb structure 1 according to this embodiment has a plurality of regions that are arranged coaxially with each other and have different opening percentages from each other in the cross section orthogonal to the extending direction of the cells 110. As shown in FIGS. 4 and 5, the plurality of regions include a central region 13 including an axial center 1c of the honeycomb structure 1, and an outer peripheral region 14 adjacent to the outer peripheral wall 10.

The opening percentage of the central region 13 is less than or equal to 0.9 times the opening percentage of the outer peripheral region 14. As used herein, the opening percentage is a value obtained by dividing areas of the cells 110 by the sum of areas of the partition walls 11 and the cells 110 in the cross section of the honeycomb structure 1 orthogonal to the extending direction of the cells 110, expressed by a percentage (a value expressed as a percentage of total cell area/(total cell area+total partition wall area). In other words, the opening percentage of each region can also be said to be an average value of the opening percentages in the corresponding region. Further, the opening percentage may be uniform within each region. The opening percentage can be adjusted by changing the thickness of the partition wall 11, the size of the R portion 112, and/or the cell density. The opening percentage can be reduced by thickening the partition wall 11, increasing the size of the R portion 112, and/or increasing the cell density.

The diameter of the central region 13 is more than or equal to 65% and less than or equal to 135% of that of the inlet 30 of the housing 3. The diameter of the inlet 30 of the housing 3 corresponds to the spread of the flow of the exhaust gas 4 toward the honeycomb structure 1. The diameter of the central region 13, that is, the position at which the opening percentage changes, will be determined based on the spread of the flow of the exhaust gas 4. As will be described below using Examples, this condition allows a response to thermal shock when the engine load increases to be improved. If the diameter of the central region 13 is less than 65% or more than 135% of that of the inlet 30 of the housing 3, the flow of the exhaust gas 4 will not spread toward the outer periphery of the honeycomb structure 1, so that the effect of suppressing a difference between inside-outside temperatures and a difference between thermal expansions may not be sufficiently exerted. The diameter of the central region 13 is preferably more than or equal to 70% and less than or equal to 130% of that of the inlet 30 of the housing 3. Here, the shape of the central region 13 is typically circular. However, the shape of the central region 13 is not limited to this, and may be other shapes such as an oval shape or a polygonal (quadrangular, pentagonal, hexagonal, heptagonal, octagonal, etc.) shape. When the shape of the central region 13 is other than the circular shape, the diameter of the central region 13 may be understood to be a diameter of the largest inscribed circle in the central region 13.

As in the first form shown in FIG. 4, the central region 13 may be provided adjacent to the outer peripheral region 14. Further, as in the second form shown in FIG. 5, the plurality of regions may further include an intermediate region 15 disposed between the central region 13 and the outer peripheral region 14. The providing of the intermediate region 15 makes it easier for the flow of the exhaust gas 4 to spread toward the outer periphery of the honeycomb structure 1, which is more preferable. The opening percentage of the intermediate region 15 can be larger than that of the central region 13 and less than that of the outer peripheral region 14.

It is preferable that the thickness of the partition walls 11 in the central region 13 is more than or equal to 1.3 times and less than or equal to 2.3 times that of the partition walls 11 in the outer peripheral region 14. The thickness of the partition walls 11 in the central region 13 which is more than 1.3 times that of the partition walls 11 in the outer peripheral region 14 allows the flow of the exhaust gas 4 to easily spread to the outer peripheral portion of the honeycomb structure 1, and the thickness which is less than or equal to 2.3 times allows a difference between the thicknesses of the partition walls 11 to become small, so that the deformation of the partition walls 11 can be suppressed during the production.

The opening percentage of the central region 13 is preferably more than or equal to 0.65 times and less than or equal to 0.8 times that of the outer peripheral region 14. As will be described below using Examples, this condition allows the response to thermal shock when the engine load increases to be significantly improved.

It is preferable that the honeycomb structure 1 according to the embodiment has the outer peripheral wall 10 and the partition walls 11 disposed on the inner side of the outer peripheral wall 10, each of the partition walls 11 defining the plurality of cells 110, each of the cells 110 extending from one end face 1a to other end face 1b to form the flow path, the honeycomb structure 1 being connected to the pair of metal electrodes 2 for applying voltage to the honeycomb structure 1, wherein the honeycomb structure 1 has the plurality of regions which are arranged coaxially with each other in the cross section orthogonal to the extending direction of the cells 110 and have different opening percentages from each other, wherein the plurality of regions include the central region 13 including the axial center 1c of the honeycomb structure 1 and the outer peripheral region 14 adjacent to the outer peripheral wall 10, and wherein the opening percentage of the region 13 is more than or equal to 0.65 and less than or equal to 0.8 times that of the outer peripheral region 14.

Further, in the honeycomb structure 1, preferably, the plurality of regions further include the intermediate region 15 disposed between the central region 13 and the outer peripheral region 14, and the opening percentage of the intermediate region 15 is more than that of the central region 13 and less than that of the outer peripheral region 14.

### EXAMPLES

Hereinafter, the present invention will be described in more detail with reference to Examples, but the present invention is not limited to these Examples in any way.

### Example 1

A ceramic raw material was prepared by mixing silicon carbide (SiC) powder and metal silicon (Si) powder at a mass ratio of 80:20. To the ceramic raw material were added hydroxypropylmethyl cellulose as a binder, a water absorbing resin as a pore former, and water to obtain a forming raw material. The forming raw material was then kneaded by a vacuum kneader to prepare a cylindrical green body. The binder content was 7 parts by mass when the total of silicon carbide (SiC) powder and metal silicon (Si) powder was 100 parts by mass. The content of the pore former was 3 parts by mass when the total of silicon carbide (SiC) powder and metal silicon (Si) powder was 100 parts by mass. The content of water was 42 parts by mass when the total of silicon carbide (SiC) powder and metal silicon (Si) powder was 100 parts by mass. The silicon carbide powder had an average particle diameter of 20 μm, and the metal silicon powder had an average particle diameter of 6 μm. Also, the pore former had an average particle diameter of 20 μm. The average particle diameter of each of the silicon carbide, the metal silicon and the pore former is a value measured by a laser diffraction method.

The obtained green body was extruded so as to have a hexagonal cell structure eventually. The resulting honeycomb formed body was in a shape provided with a portion where the partition walls 11 were thicker than the central region 13 and a portion where the partition walls 11 were thinner than the central region 13 corresponding to the outer peripheral region 14. The shape of the honeycomb formed body was adjusted by the shape of the die.

The resulting honeycomb formed body was dried by high-frequency dielectric heating and then dried at 120° C. for 2 hours using a hot air dryer, and both end faces were cut by a predetermined amount to produce a honeycomb dried body.

The obtained cylindrical green body was formed using an extruding machine having a die attached to the tip to obtain a cylindrical honeycomb formed body in which each cell had a hexagonal shape in a cross section perpendicular to the flow path direction of the cells. After the honeycomb formed body was dried by high-frequency dielectric heating, it was dried at 120° C. for 2 hours using a hot air dryer to prepare a honeycomb dried body.

Metal silicon (Si) powder, silicon carbide (SiC) powder, methyl cellulose, glycerin, and water were mixed together in a rotation and revolution agitator to prepare an electrode layer forming paste. The Si powder and the SiC powder were blended in a volume ratio of Si powder:SiC powder=40:60. Further, when the total of Si powder and SiC powder was 100 parts by mass, methyl cellulose was 0.5 parts by mass, glycerin was 10 parts by mass, and water was 38 parts by mass. The metal silicon powder had an average particle diameter of 6 μm. The silicon carbide powder had an average particle diameter of 35 μm. These average particle diameters refer to arithmetic average diameters on a volume basis when the frequency distribution of particle diameters is measured by a laser diffraction method.

The electrode layer forming paste was then applied by a curved surface printer to the side surface of the honeycomb dried body so as to have a thickness of 0.15 mm to form a coating on the honeycomb dried body.

The honeycomb dried body with the electrode layer forming paste was fired in an Ar atmosphere at 1400° C. for 3 hours. Subsequently, an oxidation treatment was performed at 1300° C. for 1 hour in an oxidizing atmosphere to produce a honeycomb structure 1.

The average pore diameter (pore diameter) of the partition walls 11 of the obtained honeycomb structure 1 was 8.6 μm, and the porosity was 45%. The average pore diameter and the porosity are values measured using a mercury porosimeter. Further, each end face of the honeycomb structure 1 was circular with a diameter of 93 mm, and the length of the honeycomb structure 1 in the extending direction of the cells 110 was 65 mm. Moreover, the isostatic strength of the obtained honeycomb structure 1 was 2.5 MPa. The isostatic strength is fracture strength measured in water under hydrostatic pressure.

Further, the opening percentage of the central region 13 was less than or equal to 0.9 times that of the outer peripheral region 14. Further, the honeycomb structure 1 had a structure in which the central region 13 and the outer peripheral region 14 were in contact with each other in the cross section orthogonal to the extending direction of the cells 110, as with the honeycomb structure 1 shown in FIG. 4. Further, in the honeycomb structure 1, the thickness (rib thickness) of the partition walls 11 in the central region 13 was 190 μm, and the thickness of the partition walls 11 in the outer peripheral region 14 was 140 μm. Further, the cell density of the central region 13 of the honeycomb structure 1 was 93.0 cells/cm², and the cell density of the outer peripheral region 14 was 93.0 cells/cm². Further, in the cross section orthogonal to the extending direction of the cells 110, the cell shape was a regular hexagon. The cell pitch was 1.11 mm. The cell pitch is a distance between the central portions of adjacent parallel partition walls (partition walls forming two opposite sides of the regular hexagon) in the thickness (partition wall thickness) direction. It should be noted that the central portion of the partition walls 11 in the thickness direction is the central position of the partition walls 11 in the thickness direction. Further, the electrical resistivity of the electrode layers 12 was 1.3 Ωcm. The R portions 112 were formed at the intersection portion 111 of each partition wall 11 in the central region 13, and the radius r of the circular arc of each R portion 112 was 0.3 mm. Further, the R portions 112 were also formed at the intersection portion 111 of each partition wall 11 in the outer peripheral region 14, and the radius r of the circular arc of each R portion 112 was 0.3 mm. Further, the opening percentage of the central region 13 was less than or equal to 66.1%, and the opening percentage of the outer peripheral region 14 was 73.8%.

The “thermal shock resistance” of the resulting honeycomb structure 1 was measured by the method described below. The results are shown in Table 1.

In Table 1, the “Rib Thickness (μm)” represents the thickness (μm) of the partition walls 11. Further, the “Cell Density (cell/cm²)” represents the number of cells per unit area (cm²) in the cross section orthogonal to the extending direction of the cells 110. Further, “Intersection R (mm)” represents the radius r of the circular arc of each R portion 112. Also, the “Opening Percentage (%)” represents the value obtained by dividing the areas of the cells 110 by the sum of the areas of the partition walls 11 and the cells 110 in the cross section orthogonal to the extending direction of the cells 110 (total cell area/(total cell area+total partition wall area), expressed as a percentage. Further, the “Opening Percentage Ratio” represents a value of a ratio of the opening percentage of the central region 13 to the opening percentage of the outer peripheral region 14 (an opening percentage of the central region 13/an opening percentage of the outer peripheral region 14). Moreover, the “Range from Center/Exhaust Pipe Diameter” represents a value of a ratio of the diameter of the central region 13 to the diameter of the inlet 30 of the housing 3 (a diameter of the central region 13/a diameter of the inlet 30 of the housing 3).

### (Thermal Shock Resistance Test (Burner Test))

A heating and cooling test of the honeycomb structure 1 was conducted using a propane gas burner tester equipped with the housing 3 for storing the honeycomb structure 1 and a propane gas burner capable of feeding a heating gas into the housing 3. The inlet 30 of the housing 3 was circular with a diameter of 50 mm, and the honeycomb structure 1 was arranged coaxially with the inlet 30. The heating gas was a combustion gas generated by burning propane gas with a gas burner (propane gas burner). Then, the thermal shock resistance was evaluated by checking whether or not cracks were generated in the honeycomb structure 1 through the above heating and cooling test. Specifically, first, the honeycomb structure 1 was housed (canned) in the housing 3. Then, the gas (combustion gas) heated by the propane gas burner was fed into the housing 3 from the inlet 30 of the housing 3 and passed through the honeycomb structure 1. The temperature conditions of the heated gas flowing into the housing 3 (inlet gas temperature conditions) were set as follows. First, the temperature was raised to 900° C. in 5 minutes, maintained at 900° C. for 10 minutes, then lowered to 100° C. in 5 minutes, and maintained at 100° C. for 10 minutes. A series of operations of such rising of the temperature, maintaining of the temperature, lowering of the temperature, and maintaining of the temperature are referred to as “temperature raising and temperature lowering operations”. Subsequently, cracks in the honeycomb structure 1 were confirmed. Then, the above “temperature raising and temperature lowering operations” were repeated while increasing the specified temperature by 25° C. from 900° C. The specified temperature was increased by 25° C. until the cracks were generated in the sample. As the specified temperature increases, the steepness of the temperature rise increases and the center of the honeycomb structure 1 is rapidly heated, which will delay an increase in the temperature of the radially outer peripheral portion of the honeycomb structure 1 and increase initiation stress due to the difference between the thermal expansions inside and outside in the radial direction. Table 1 shows the specified temperature at which the cracks were generated in each sample.

TABLE 1

| | Honeycomb Structure | | | | | | | | |
|---|---|---|---|---|---|---|---|---|---|
| | Central Region | | | | | Outer Peripheral Region | | | |
| | Rib | Cell | Intersection | Opening | Range from | Rib | Cell | Intersection | Opening |
| | Thickness | Density | R | Percentage | Center/Exhaust | Thickness | Density | R | Percentage |
| | (μm) | (cells/cm²) | (mm) | (%) | Pipe Diameter | (μm) | (cells/cm²) | (mm) | (%) |
| Comp. 1 | 140 | 93.0 | 0.3 | 73.8 | — | — | — | — | — |
| Comp. 2 | 190 | 93.0 | 0.3 | 66.1 | 0.5 | 140 | 93.0 | 0.3 | 73.8 |
| Comp. 3 | 190 | 93.0 | 0.3 | 66.1 | 1.4 | 140 | 93.0 | 0.3 | 73.8 |
| Ex. 1 | 190 | 93.0 | 0.3 | 66.1 | 1.0 | 140 | 93.0 | 0.3 | 73.8 |
| Ex. 4 | 190 | 93.0 | 0.3 | 66.1 | 1.0 | 140 | 93.0 | 0.3 | 73.8 |
| Ex. 2 | 190 | 93.0 | 0.3 | 66.1 | 0.7 | 140 | 93.0 | 0.3 | 73.8 |
| Ex. 3 | 190 | 93.0 | 0.3 | 66.1 | 1.3 | 140 | 93.0 | 0.3 | 73.8 |
| Ex. 5 | 240 | 93.0 | 0.3 | 58.9 | 1.0 | 140 | 93.0 | 0.3 | 73.8 |
| Ex. 6 | 280 | 93.0 | 0.3 | 53.4 | 1.0 | 140 | 93.0 | 0.3 | 73.8 |
| Ex. 7 | 320 | 93.0 | 0.3 | 48.1 | 1.0 | 140 | 93.0 | 0.3 | 73.8 |
| Ex. 8 | 350 | 93.0 | 0.3 | 44.3 | 1.0 | 140 | 93.0 | 0.3 | 73.8 |

| | | | | | | Thermal |
|---|---|---|---|---|---|---|
| | Honeycomb Structure | | | | | Shock |
| | | Intermediate Region | | | | Resistance |
| | Opening | Rib | Cell | Intersection | Opening | Heating |
| | Percentage | Thickness | Density | R | Percentage | Test |
| | Ratio | (μm) | (cells/cm²) | (mm) | (%) | Results |
| Comp. 1 | — | — | — | — | — | 900 |
| Comp. 2 | 0.90 | 170 | 93.0 | 0.3 | 69.1 | 925 |
| Comp. 3 | 0.90 | 170 | 93.0 | 0.3 | 69.1 | 925 |
| Ex. 1 | 0.90 | — | — | — | — | 950 |
| Ex. 4 | 0.90 | 170 | 93.0 | 0.3 | 69.1 | 950 |
| Ex. 2 | 0.90 | 170 | 93.0 | 0.3 | 69.1 | 950 |
| Ex. 3 | 0.90 | 170 | 93.0 | 0.3 | 69.1 | 950 |
| Ex. 5 | 0.80 | 200 | 93.0 | 0.3 | 64.6 | 975 |
| Ex. 6 | 0.72 | 210 | 93.0 | 0.3 | 63.2 | 575 |
| Ex. 7 | 0.65 | 230 | 93.0 | 0.3 | 60.3 | 975 |
| Ex. 8 | 0.60 | 250 | 93.0 | 0.3 | 57.5 | 950 |

### Examples 2 to 8, Comparative Examples 1 to 3

Honeycomb structures 1 were produced by the same method as that of Example 1, with the exception that each condition was changed as shown in Table 1. Comparative Example 1 is an example that does not have the outer peripheral region 14 and the intermediate region 15. Comparative Examples 2 and 3 and Examples 2 to 8 are examples in which the intermediate region 15 is provided between the central region 13 and the outer peripheral region 14, as shown in FIG. 5. The “thermal shock resistance” of each honeycomb structure 1 was measured by the same method as that of Example 1. The results are shown in Table 1.

As can be seen from Table 1, Examples 1 to 8 suppressed the generation of cracks to the higher temperatures than in Comparative Examples 1 to 3. It indicates that when the diameter of the central region 13 more than or equal to 65% and less than or equal to 135% of the diameter of the inlet 30 of the housing 3 allows the response to thermal shock to be improved when the engine load increases. In particular, the comparison of Examples 2 and 3 with Comparative Examples 2 and 3 revealed the usefulness of the diameter of the central region 13 more than or equal to 65% and less than or equal to 135% of the diameter of the inlet 30 of the housing 3. Furthermore, Examples 5 to 7 suppressed the generation of cracks to further higher temperatures. This revealed the usefulness of the opening percentage of the central region 13 more than or equal to 0.65 times and less than or equal to 0.8 times the opening percentage of the outer peripheral region 14.

### DESCRIPTION OF REFERENCE NUMERALS

1: honeycomb structure
1a: end face
1b: end face
10: outer peripheral wall
11: partition wall
12: electrode layer
13: central region
14: outer peripheral region
15: intermediate region
2: metal electrode
3: housing
30: inlet
31: outlet
4: exhaust gas

1. An electrically heating catalytic converter, comprising:
a honeycomb structure having an outer peripheral wall and partition walls disposed on an inner side of the outer peripheral wall, the partition walls defining a plurality of cells each extending from one end face to other end face to form a flow path;
a pair of metal electrodes connected to the honeycomb structure to apply voltage to the honeycomb structure; and
a housing provided with an inlet and an outlet for allowing an exhaust gas from an engine to flow therethrough, the housing storing the honeycomb structure therein between the inlet and the outlet,
wherein the honeycomb structure has a plurality of regions disposed coaxially with each other in a cross section orthogonal to an extending direction of the cells, the plurality of regions having different opening percentages from each other,
wherein the plurality of regions comprise a central region including an axial center of the honeycomb structure and an outer peripheral region adjacent to the outer peripheral wall,
wherein the opening percentage of the central region is less than or equal to 0.9 times that of the outer peripheral region, and
wherein a diameter of the central region is more than or equal to 65% and less than or equal to 135% of that of the inlet of the housing.

2. The electrically heating catalytic converter according to claim 1,
wherein the plurality of regions further comprise an intermediate region disposed between the central region and the outer peripheral region, and
wherein the opening percentage of the intermediate region is larger than the opening percentage of the central region and less than the opening percentage of the outer peripheral region.

3. The electrically heating catalytic converter according to claim 1, wherein the thickness of the partition walls in the central region is more than or equal to 1.3 times and less than or equal to 2.3 times that of the partition walls in the outer peripheral region.

4. The electrically heating catalytic converter according to claim 1, wherein the opening percentage of the central region is more than or equal to 0.65 times and less than or equal to 0.8 times that of the outer peripheral region.

5. The electrically heating catalytic converter according to claim 3, wherein the opening percentage of the central region is more than or equal to 0.65 times and less than or equal to 0.8 times the opening percentage of the outer peripheral region.

6. The electrically heating catalytic converter according to claim 1, wherein the honeycomb structure further comprises a pair of electrode layers provided on the outer surface of the outer peripheral wall so as to extend in a band shape in the extending direction of the cells across an axial center of the honeycomb structure.
